(19) United States
(12) Patent Application Publication
(10) Pub. No.: US 2022/0078261 A1
(43) Pub. Date: Mar. 10, 2022

(54) CONTROLLING CLIENT/SERVER INTERACTION BASED UPON INDICATIONS OF FUTURE CLIENT REQUESTS

(71) Applicant: Microsoft Technology Licensing, LLC, Redmond, WA (US)

(72) Inventor: Adhithya RAJASEKARAN, Redmond, WA (US)

(21) Appl. No.: 17/017,166

(22) Filed: Sep. 10, 2020

(51) Int. Cl. H04L 29/08; H04L 29/06

(52) U.S. Cl. CPC H04L 67/327; H04L 67/2857; H04L 67/22; H04L 67/42

(57) ABSTRACT

A client component identifies a dependent request, that is dependent from an initial request to be made to a service. The client component generates preview information, indicative of the dependent request, and provides the preview information to the service computing system before receiving a response to the initial request. The preview information enables the service computing system to obtain information responsive to the dependent request, before the dependent request is made by the client computing system.

### BACKGROUND

Computing systems are currently in wide use. Some computing systems are deployed in a client/server architecture. In such an architecture, a server computing system hosts a service or web applications that is accessed by client computing systems. The client computing systems may have a client component that interacts with the service or web application.

In most of these types of web-based applications, the client component has logic that allows the client computing system to make requests to the service computing system in order to obtain data or perform some action. However, the service computing system does not know which requests the client computing system is going to make, in advance of receiving those requests. This can increase latency of the service in responding to such requests.

In order to reduce this type of latency, some service computing systems cache data that has been previously requested so that, if it is requested again, the service computing system can respond more quickly. Other service computing systems use machine learning algorithms in an attempt to predict what requests will be made in the future, based upon prior usage patterns. The data responsive to the predicted requests is then obtained and cached so that, if those requests are received in the future, the service computing system can respond to them more quickly.

The discussion above is merely provided for general background information and is not intended to be used as an aid in determining the scope of the claimed subject matter.

### SUMMARY

A client component identifies a dependent request, that is dependent from an initial request to be made to a service. The client component generates preview information, indicative of the dependent request, and provides the preview information to the service computing system before receiving a response to the initial request. The preview information enables the service computing system to obtain information responsive to the dependent request, before the dependent request is made by the client computing system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram showing one example of a computing system architecture.

FIG. 2 is a block diagram showing one example of the computing system architecture illustrated in FIG. 1, in more detail.

FIG. 3 is a flow diagram illustrating one example of the operation of the client computing system in making a request to the service computing system, as well as in providing preview information.

FIGS. 4 and 5 show examples of dependency structures that may be maintained by the client computing system.

FIG. 6 is a flow diagram illustrating one example of the operation of the service computing system in responding to a request from the client computing system, and in responding to preview information.

FIG. 7 is a block diagram of a remote server architecture.

FIG. 8 is a block diagram showing one example of a computing environment that can be used in the architectures illustrated in the previous figures.

### DETAILED DESCRIPTION

As mentioned above, because a service computing system does not know which requests are coming from clients, it must wait to receive those requests before obtaining data or performing operations responsive to the future requests. This can increase the latency in responding to requests. Some current systems that cache previously requested data, or that use machine learning to predict future requests, and cache data responsive to the predicted requests, do not remedy the latency issue. For instance, the cached data may never be requested by the client computing systems, as the client computing systems, themselves, decide what data they are going to request next, and not the server computing system. While this can be ineffective in addressing latency issues, it can also waste computing resources used in maintaining the cache.

The present description thus proceeds with respect to a client component that identifies dependent requests that are dependent upon an initial request that the client is about to make. The dependent requests are those requests that will be made, based upon the initial request. The client computing system then provides, along with the initial request or as a separate request, preview information indicating which dependent requests are about to be made. The preview information can be added to the initial request (such as in an HTTP header or in an appended data portion), or it can be provided as a separate preview request. The service computing system identifies the dependent requests that are about to be made, from the preview information, and generates a response to the dependent requests so the response can be provided to the client computing system with relatively low latency. In one example, the information responsive to the dependent requests is cached by the server so that, as soon as the dependent requests are received from the client computing system, the responsive information can be provided from cache. In another example, the responsive information can be pushed to the client computing system, even before the dependent requests are made by the client computing system.

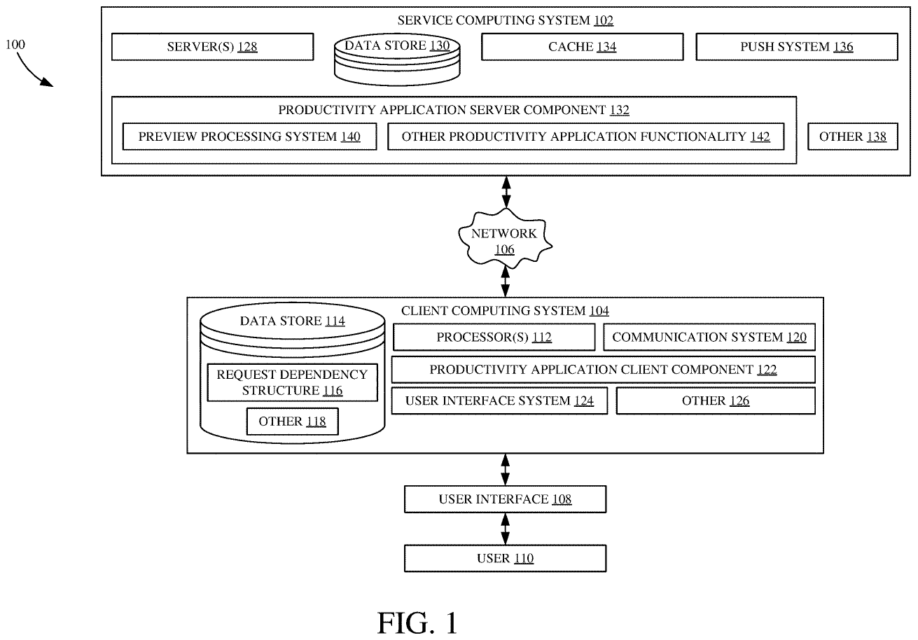

FIG. 1 is a block diagram of one example of a computing system architecture 100 that includes a service computing system 102 and a client computing system 104. Client computing system 104 can access service computing system 102 using network 106. Therefore, network 106 can be a wide variety of different types of networks such as a wide area network, a local area network, a near field communication network, a cellular communication network, or any of a wide variety of other networks, or combinations of networks.

Client computing system 104 is shown generating user interfaces 108 for interaction by user 110. User 110 can interact with user interfaces 108 in order to control and manipulate client computing system 104 and some portions of service computing system 102. In the example illustrated in FIG. 1, service computing system 102 hosts a web-based productivity application for access by client computing system 104. Thus, user 110 can use the web-based productivity application by interacting with client computing system 104.

Client computing system 104 illustratively includes one or more processors 112, data store 114 (which, itself, can include request dependency structure 116 and other items 118), communication system 120, productivity application client component 122, user interface system 124, and it can include other items 126. Service computing system 102 can include one or more servers 128, data store 130, productivity application server component 132, cache 134, push system 136, and it can include other items 138. Productivity application server 132 can include preview processing system 140, and a wide variety of other productivity application functionality 142. Before describing the overall operation of architecture 100 in more detail, a brief description of some of the items in architecture 100, and their operation, will first be provided. Productivity application client component 122 is illustratively a client component of a productivity application hosted by productivity application server component 132 on service computing system 102. Therefore, productivity application client component 122 can use communication system 120 to make requests to productivity application server component 132. The requests can request client data. The requests can request that productivity functionality 142 perform an operation on client data, or the requests can request other operations. In one example, user 110 can interact with user interface 108 in order to provide a user input indicating that productivity application client component 122 should make a request. By way of example, where the productivity application is a project management application, then user 110 may provide an input indicating that the user wishes to open a project in the project management application and have certain data displayed. In that case, productivity application client component 122 can generate an open project request that can be provided to service computing system 102 to open a project.

Productivity application server component 132 illustratively hosts the productivity, application and exposes an interface on a front-end system, which can be accessed by client computing system 104. The front-end system receives the requests from client computing system 104 and the productivity application functionality 142 handles those requests and provides them to a back-end system which accesses client data in data store 130. In response to the requests, functionality 142 can generate a response to the requests by retrieving data from data store 130, performing an operation on data in data store 130, or otherwise generate a result that can be returned to client computing system 104.

Many applications are structured in a way in which a given request may have one or more dependent requests. The dependent requests are those requests that are always made after the given request. For instance, it may be that every time an “open project” request is made, then three dependent requests are always made after the “open project” request, such as “get tasks”, “get assignments”, and “get resources”. The logic is built into the productivity application client component 122 so that component 122 automatically generates the three dependent requests once it receives a response to the initial request (the initial request being the request on which the dependent request depend in this example, the “open project” request). This dependency among the various requests can be identified by logic in productivity application client component 122 and encoded by component 122 in a request dependency structure 116. The request dependency structure 116 that identifies the dependency among requests that are made in executing functionality of the productivity application.

In one example, productivity application client component 122 builds or obtains the request dependency structure 116 either prior to execution of the productivity application or dynamically during execution of the productivity application. Then, when productivity application client component 122 is about to make a request, component 122 first accesses the request dependency structure 116 in data store 114 and identifies any dependent requests, which are dependent from (and will thus be made) after the initial request that client component 122 is about to make. Productivity application client component 122 then generates preview information obtained from the dependency structure 116. The preview information identifies the dependent requests that are soon to be made, after the initial request, as well as other information that may be used to make the dependent request such as authorization and/or authentication information (e.g., tokens), and other information. Client component 122 then provides the initial request, and the preview information, to productivity application server component 132.

The productivity application functionality 142 generates a response to the initial request (such as by obtaining data from data store 130, performing an operation, etc.), and preview processing system 140 accesses the preview information and identifies the dependent requests that are about to be received by server component 132, after server component 132 responds to the initial request. Then, after the time when productivity application server component 132 has executed the initial request, preview processing system 140 begins to generate the responses to the dependent requests that are about to be made by client computing system 104. Thus, if a dependent request is to retrieve data, preview processing system 140 retrieves the data corresponding to the dependent request from data store 130 and prepares it to be sent to client computing system 104.

In one example, preview processing system 140 caches the responsive data (responsive to the dependent request) in cache 134 so that once the dependent request is received from client computing system 104, functionality 142 can quickly respond to the dependent request by retrieving the data form cache 134 instead of having to perform a database operation on data store 130 to retrieve the data. In another example, when push system 136 is configured to push data to client computing system 104, then preview processing system 140 generates a response to the dependent request and uses push system 136 to push that response to client computing system 104, even before client computing system 104 makes the dependent requests.

In one example, request dependency structure 116 can be generated by logic in productivity application client component 122 during operation of the productivity application. In another example, request dependency structure 116 can be pre-generated. Also, request dependency structure 116 can take any of a wide variety of different forms. For instance, it can be represented as a dependency graph in memory where parent nodes are connected to child nodes. Each node may represent a request that client component 122 can make to server component 132. The edges may represent a dependency among those requests. For instance, nodes that are lower down in the hierarchy (e.g., child nodes) may be dependent requests which depend from a node that is higher up in the hierarchy (e.g., parent nodes). Thus, each time a request is to be made, client component 122 can access (as a parent node) a node in dependency structure 116 corresponding to the request and traverse the dependency structure 116 to identify dependent nodes (or child nodes) that depend from the parent node and represent dependent requests which are to be made after the request corresponding to the parent node is made.

Client component 122 can generate preview information identifying the dependent requests represented by all of the child nodes, that are connected to the parent node and provide the preview information to server component 132. Server component 132 can identify the dependent requests from the preview information and then begin assembling the data or performing operations in order to generate responses to the dependent requests, even before those dependent requests are received from client component 122.

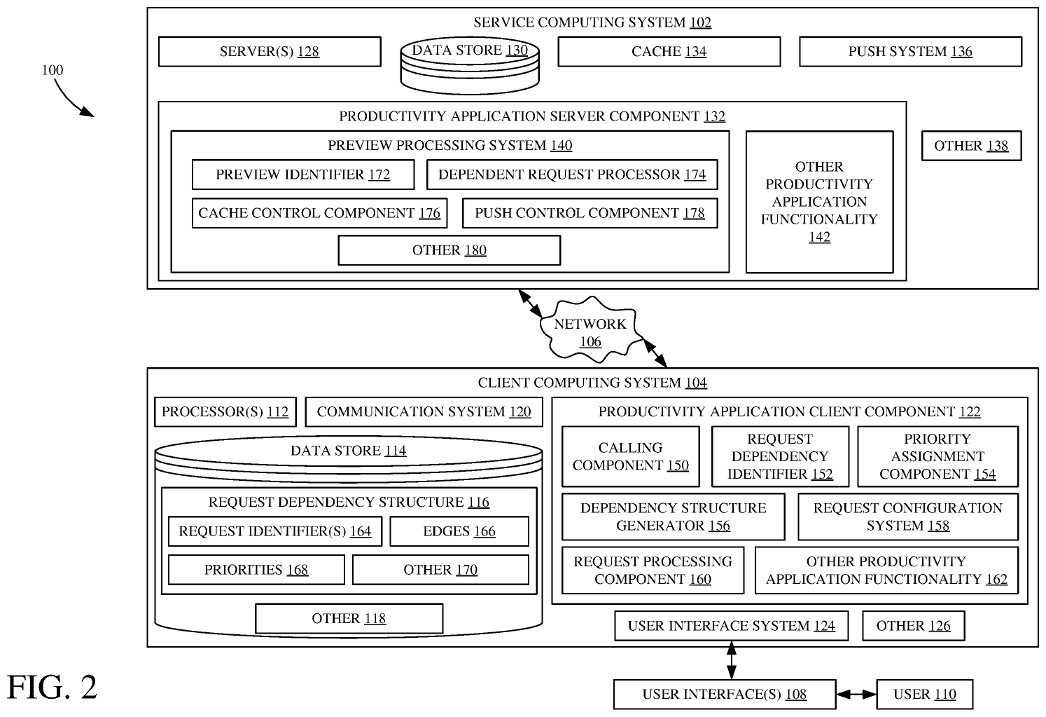

FIG. 2 is a block diagram showing portions of architecture 100 in more detail. FIG. 2 shows that productivity application client component 122 may include calling component 150, request dependency identifier 152, priority assignment component 154, dependency structure generator 156, request configuration system 158, request processing component 160 and other productivity application functionality 162. Request dependency structure 116 can include request identifiers (e.g., nodes) 164, edges 166 that connect the request identifiers 164 in a hierarchical way, priorities 168 that are assigned to each request on a same level of the hierarchical structure, and it can include other items 170. FIG. 2 also shows that productivity application server component 132 can include preview identifier 172, dependent call processor 174, cache control component 176, push control component 178, and other items 180.

Briefly, in operation, calling component 150 handles interactions through communication system 120 with productivity application server component 132. Therefore, calling component 150 may make requests using communication system 120, to productivity application server component 132, and receive responses to those requests.

Dependency structure generator 156 generates the dependency structure 116 corresponding to the requests that are to be made by calling component 150. In one example, dependency structure generator 156 can generate the request dependency structure 116 ahead of time. In another example, dependency structure generator 156 generates portions of the dependency structure corresponding to requests, as those requests are about to be made to productivity application server component 132. The request dependency structure 116 can include request identifiers 164 which may correspond to nodes in a hierarchical tree structure. The dependency structure 116 can include edges 166 which connect child (or dependent) nodes to their parent nodes and which indicate a dependency of the child node on the parent node. Thus, the edges 166 also indicate a dependency of a request corresponding to a child node on a request corresponding to the connected parent node.

Priority assignment component 154 assigns priorities 168 to any dependent requests. Priorities 168 can identify priorities among dependent requests. For instance, if three dependent requests are all dependent from a same parent request, then priority assignment component 154 assigns a priority to the three dependent requests indicating the order in which those dependent requests are to be made to the server. By way of example, some network implementations restrict the number of parallel open connections. The priorities can be assigned to help ensure that requests are made in the correct priority order. Also, some client components 122 have logic that ensures that critical data, which may be identified as being critical using criteria that vary based on the application, gets loaded before non-critical data. In the above example in which the initial request is an “open project” request, then it may be that the “tasks” are more critical than the “assignments” so the dependent request “get tasks” may have a higher priority than the dependent request “get assignments.”

When calling component 150 is to make a request to server component 132, then request dependency identifier 152 identifies dependent requests, that are dependent from a request that calling component 150 is about to make or has just made and the priorities assigned to the dependent requests. Request configuration system 158 configures the request that is to be made by calling component 150. Request processing component 160 handles processing of the configured request by providing it to calling component 150 when it is time to make the request. Request processing component 160 can also initiate making the dependent requests, as well. Other productivity application functionality 162 can perform other operations to identify subsequent requests that are to be made, and to process the results retuned by productivity application server component 132, in response to those requests.

In one example, preview information generated based on request dependency structure 116 is provided to sever component 132 as part of the request that calling component 150 is about to make. In that example, request configuration system 158 places the preview information in a specific place in the initial request. For instance, the preview information may be placed in an HTTP header in the request that calling component 150 is about to make (referred to herein as the initial request), or be appended to a different portion of the initial request. In either case, preview identifier 172, in server component 132, knows where the preview information will be placed in the initial request. In another example, the preview information may be sent as a separate request, in which case request configuration system 158 configures the preview information into a preview request, and request processing system 160 provides that configured preview request to calling component 150 which can provide the preview information, as a preview request, to preview processing system 140.

Once the initial request and the corresponding preview information are provided to preview processing system 140, preview identifier 172 identifies the preview information, and the dependent requests that are identified by the preview information. Productivity application functionality 142 begins to generate a response to the initial request, and dependent request processor 174 begins generating responses to the dependent requests. Responses to the dependent requests are generated in an order identified by the priority assigned to each dependent request.

In one example, dependent request processor 174 uses cache control component 176 to place the responses to the dependent requests in cache 134. In this way, once client computing system 104 makes the dependent requests, dependent request processor 174 simply retrieves the responsive information from cache 134 and provides it to client computing system 104.

In another example, push control component 176 receives the responsive information, that is responsive to the dependent requests, from dependent request processor 174, and controls push system 136 to push the responsive information to client computing system 104, even before client computing system 104 makes the dependent requests. In either case, the latency with which productivity application server component 132 provides information responsive to the dependent requests, is greatly reduced over systems that wait to receive dependent requests before generating responses to them.

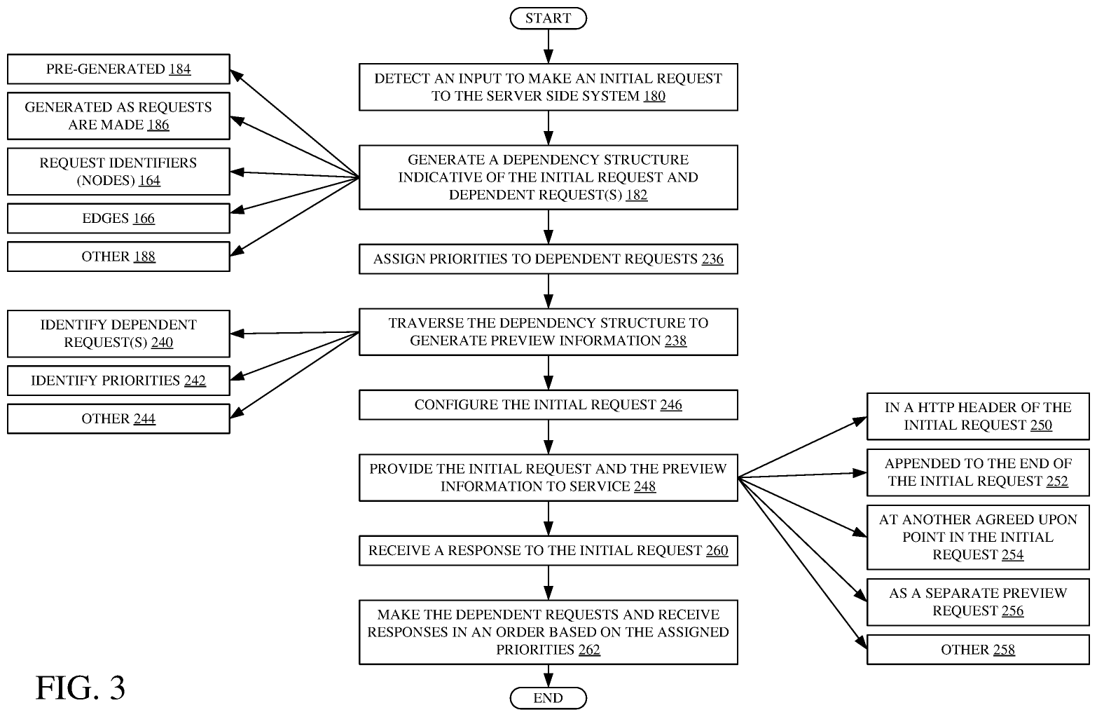

FIG. 3 is a flow diagram illustrating one example of the operation of productivity application client component 122 in generating a request, providing that request to productivity application server component 132, generating preview information indicative of dependent requests, and providing the preview information to server component 132. At some point, productivity application client component 122 detects an input to make an initial request to productivity application server component 132. This is indicated by block 180 in the flow diagram of FIG. 3. The input can be a user input from user 110, or an automated input from some other component in client computing system 104 or from other productivity application functionality 162. It will be noted that by “initial request” this does not necessarily mean a very first request. Instead, it means any request for which dependent requests are to be identified.

Dependency structure generator 156 may then generate or obtain dependency structure 116 indicative of the initial request and the dependent requests. Productivity application functionality 162 illustratively includes logic that identifies which requests are dependent on which other requests. Therefore, dependency structure generator 156 can generate or obtain request dependency structure 116 to reflect those dependencies. Generating or obtaining the dependency structure is indicated by block 182 in the flow diagram of FIG. 3. In one example, request dependency structure 116 can be pre-generated, before any requests are made, or at any point during the operation of productivity application client component 122. Pre-generating the request dependency structure 116 is indicated by block 184 in the flow diagram of FIG. 3. As discussed above, the dependency structure 116 can also be dynamically generated or updated as requests are made, or as they are about to be made. This is indicated by block 186. For instance, when calling component 150 determines that a request is to be made to productivity application server component 132, then dependency structure generator 156 can generate the portion of the dependency structure 116 corresponding to that request, and any dependent requests.

The dependency structure 116 can take a wide variety of forms. In one example, it includes a set of hierarchically arranged request identifiers (which may be nodes in a tree structure). This is indicated by block 164. The nodes may be connected by edges 166 which reflect the dependency among the nodes. The dependency structure can take other forms as well, as indicated by block 188. Priorities can be assigned to each request identifier as well, as indicated by block 236.

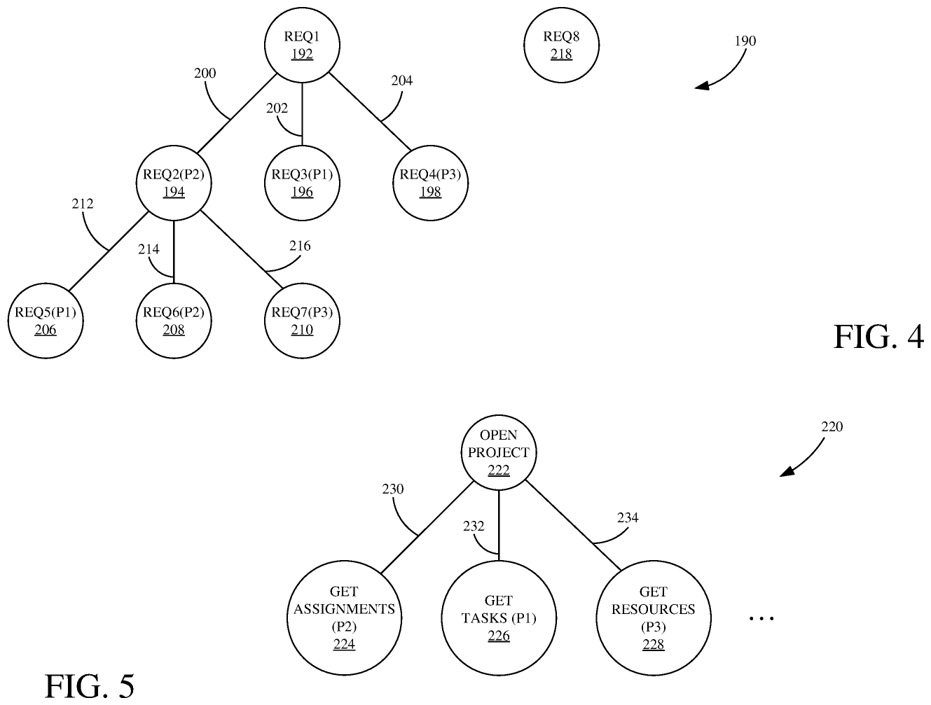

FIGS. 4 and 5 show examples of dependency structures that can be generated. In the example shown in FIG. 4, a dependency structure 190 is generated based upon a request (Request 1) represented by node 192. The Request 1 may have a plurality of dependent requests (Request 2, Request 3 and Request 4) represented by nodes 194, 196 and 198 in dependency structure 190. Nodes 194, 196 and 198 are connected to node 192 by edges 200, 202 and 204, respectively. Edges 200-204 indicate that dependent nodes 194-198 are dependent from node 192. Thus, edges 200-204 indicate that the requests represented by nodes 194-198 (e.g., Request 2, Request 3 and Request 4) are all dependent from the request represented by node 192 (Request 1), and will thus be executed after Request 1 is made. Because dependent nodes 194-198 are all on the same hierarchical level in structure 190, each of the requests corresponding to those nodes is assigned a priority, indicating the order in which the dependent requests are to be made, once a response is received to Request 1. FIG. 4 shows that Request 3 is given a priority level of P1, Request 2 is given a priority level of P2 and Request 4 is given a priority level of P3. This indicates that Request 3 will be executed before Request 2, which will be executed before Request 4.

Dependency structure 190 also shows that Request 2 has a plurality of dependent requests (Request 5, Request 6 and Request 7), each having an assigned priority (with Request 5 having a priority of P1, Request 6 having a priority of P2 and Request 7 having a priority of P3). Each of the dependent Requests 5-7 are represented by a node 206, 208 and 210, respectively. Nodes 206-210 are connected to node 194 by edges 212, 214 and 216, respectively, indicating that the requests represented by nodes 206-210 are dependent from the request represented by node 194. FIG. 4 also shows that dependency structure 190 includes an additional node 218 that represents another request, Request 8. Request 8 is not dependent from any other requests, and has no dependent requests, as indicated by dependency structure 190.

FIG. 5 shows another example of a different dependency structure 220. Dependency structure 220 has a first (or parent) node 222 and a plurality of dependent nodes 224, 226 and 228 that are connected to parent node 222 by edges 230, 232 and 234, respectively. Node 222 represents an “open project” request that may be made by productivity application client component 122 to productivity application server component 132, where the productivity application is a project management application. Any time the application performs an “open project” command, it also subsequently performs three additional commands which include “get assignments”, “get tasks”, and “get resources”. However, it performs the “get tasks” request first and then performs the “get assignments” request and then the “get resources” request. Thus, dependency structure 220 shows that the request represented by node 224 has a priority of P2 whereas the request represented by node 226 has a P1 priority. The request represented by node 228 has a P3 priority. The dependencies in dependency structure 220 are illustratively specified in the logic of the productivity application run by client component 122. The dependencies can be separately referenced in metadata, or they can be documented in other ways, so that dependency structure generator 156 can generate the dependency structure for the various requests that may be performed by productivity application client component 122.

Returning again to the flow diagram of FIG. 3, once calling component 150 identifies a particular request that is to be made, then request dependency identifier 152 walks the dependency structure to identify any dependent requests. For example, assume that calling component 150 has determined that it is to make the “open project” request represented by node 222 in FIG. 5. Request dependency identifier 152 then starts at node 222 and traverses dependency structure 220, following edges 230, 232 and 234, to identify other nodes that are dependent from node 222. For each dependent node (in this example, nodes 224-228) request dependency identifier 152 identifies the particular dependent requests represented by those nodes. It also illustratively identifies the priority assigned to each of those requests, by priority assignment component 154.

The dependent requests, and their corresponding priorities, can comprise the preview information that will be sent to productivity application server component 132. Traversing the dependency structure to generate the preview information is indicated by block 238 in the flow diagram of FIG. 3. Identifying dependent requests while traversing the dependency structure is indicated by block 240. Identifying the corresponding priorities is indicated by block 242. The dependency structure can be traversed to identify preview information in other ways as well, and this is indicated by block 244.

Either while request dependency identifier 152 is generating the preview information, or afterwards, request configuration system 158 configures the initial request so that it can be provided to the productivity application server component 132. Configuring the initial request is indicated by block 246 in the flow diagram of FIG. 3. Calling component 150 then provides the initial request to productivity application server component 132. It also provides the preview information as well. Providing the initial request and the preview information to productivity application server component 132 is indicated by block 248 in the flow diagram of FIG. 3.

The preview information can be provided along with the initial request, or separately from the initial request. For instance, in one example, request configuration system 158 configures the initial request so the preview information is included in an HTTP header of the initial request. This is indicated by block 250. In another example, the preview information is appended to the end of the initial request, or at another agreed upon point in the initial request, as indicated by blocks 252 and 254 in the flow diagram of FIG. 3. In yet another example, the preview information can be provided as a separate, preview request that is configured by request configuration system 158 and provided by calling component 150. Providing the preview information in a separate preview request is indicated by block 256 in the flow diagram of FIG. 3. The initial request and preview information can be provided to the service in other ways as well, and this is indicated by block 258.

Request processing component 160 handles the sequencing of the request, and dependent requests, and also handles receipt of responses to those requests. The responses can be provided to the other productivity application functionality 162 for further processing. Receiving a response to the initial request is indicated by block 260 in the flow diagram of FIG. 3. Making the dependent requests and receiving responses in an order based upon the assigned priorities is indicated by block 262.

As mentioned above, request processing component 160 may control calling component 150 to make the dependent requests, in priority order, upon receiving a response to the initial request. In another example, the responses to the dependent requests are pushed to client computing system 104, in which case request processing component 160 handles receipt of the pushed responses, and provides those responses to the other productivity application functionality 162.

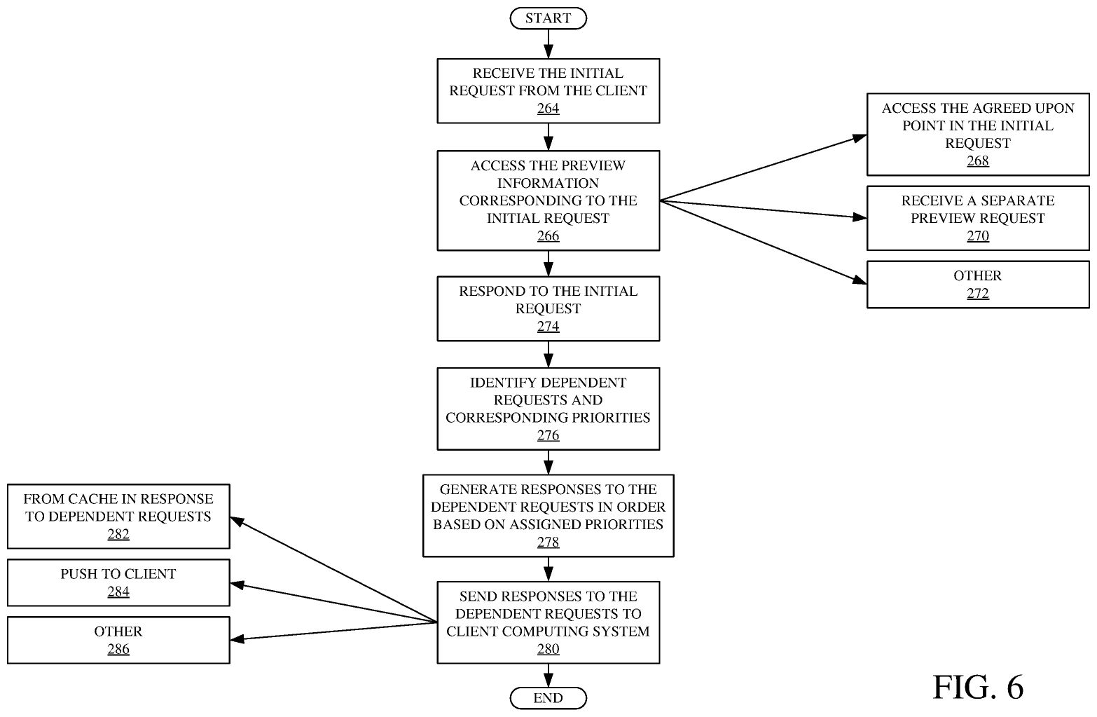

FIG. 6 is a flow diagram illustrating one example of the operation of service computing system 102, in receiving a request and corresponding preview information. It is first assumed that productivity application server component 132 receives the initial request from client computing system 104. This is indicated by block 264 in the flow diagram of FIG. 6.

Preview identifier 172 then accesses the preview information corresponding to the initial request. This is indicated by block 266. In one example, when the preview information is provided as part of the initial request, then preview identifier 172 accesses the agreed upon point in the initial request that contains the preview information. This is indicated by block 268. In another example, when the preview information is received as part of a separate, preview request, then preview identifier 172 accesses the preview information in the preview request. This is indicated by block 270. Preview identifier 172 can identify the preview information in other ways as well, and this is indicated by block 272.

Productivity application functionality 142 processes and responds to the initial request, as indicated by block 274. Once productivity application functionality 142 has finished executing the initial request, dependent request processor 174 identifies the dependent requests in the preview information, and their corresponding priorities. This is indicated by block 276 in the flow diagram of FIG. 6. The dependent requests are provided, in priority order, to the productivity application functionality 142 which processes the dependent requests, and generates responses to those dependent requests. Generating the responses to the dependent requests, in the order based upon the assigned priority, is indicated by block 278 in the flow diagram of FIG. 6.

Productivity application server component 132 then sends the responses, to the dependent requests, to client computing system 104. This is indicated by block 280 in the flow diagram of FIG. 6. In an example in which productivity application server component 132 waits to receive the dependent requests, before responding to them, then the cache control component 176 stores the responses to the dependent requests in cache 134. When the corresponding dependent requests are received by server component 132, cache control component 176 retrieves the responsive information from cache 134 and provides it back to client computing system 104. This greatly reduces the latency that otherwise occurs in responding to the dependent requests. Providing the responses to the dependent requests from cache 134 is indicated by block 282 in the flow diagram of FIG. 6.

In an example in which productivity application server component 132 provides the responses to the dependent requests using a push model, then push control component 178 controls push system 136 to push the responses to the dependent requests to client computing system 104. This can be done even before client computing system 104 sends the dependent requests to the server. Pushing the responses to the dependent requests to the client computing system 104 is indicated by block 284 in the flow diagram of FIG. 6. This also greatly reduces the latency in providing responses to dependent requests.

The responses to the dependent requests can be provided to client computing system 104 in other ways as well. This is indicated by block 286 in the flow diagram of FIG. 6.

It can thus be seen that the present description enhances the operation of the client/server architecture by using a dependency structure on the client to provide preview information from the client to the service, indicative of dependent requests that are about to be made, so the service can generate responses to those dependent requests even before the dependent requests are received at the service. The service can provide the responsive information out of cache, when it receives the dependent requests, or it can push the responsive information to the client. This greatly reduces the latency of the client/server architecture. It also reduces or eliminates any wasted cache which may be encountered by systems that attempt to predict future requests using machine learning, or which simply cache information that has already been requested, assuming that it will be requested again.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

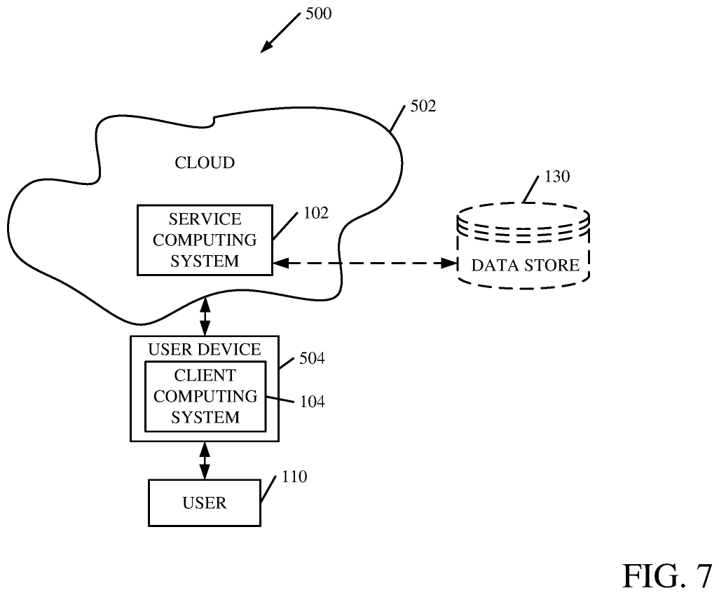

FIG. 7 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 7, some items are similar to those shown in FIG. 1 and they are similarly numbered. FIG. 7 specifically shows that service computing system 102 can be located in cloud 502 (which can be public, private, or a combination where portions are public while others are private). Therefore, user 110 uses a user device 504 to access those systems through cloud 502.

FIG. 7 also depicts another example of a cloud architecture. FIG. 7 shows that it is also contemplated that some elements of computing system 102 can be disposed in cloud 502 while others are not. By way of example, data store 130 can be disposed outside of cloud 502, and accessed through cloud 502. Regardless of where they are located, the items in service computing system 102 can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

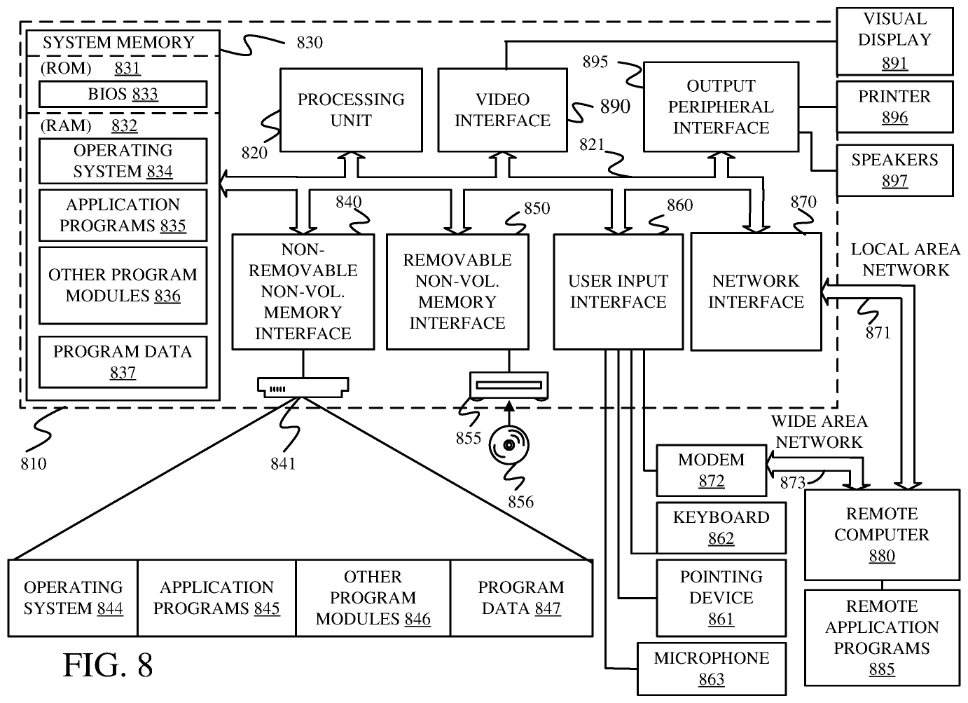

FIG. 8 is one example of a computing environment in which architecture 100, or parts of it, (for example) can be deployed. With reference to FIG. 8, an example system for implementing some embodiments includes a computing device in the form of a computer 810 programmed to operate as discussed above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer system, comprising:

an application client component configured to identify, at a client component of a hosted application, a first request to submit to a service computing system;

a request dependency identifier identifying a dependent request, that is dependent on the first request, and generating preview information indicative of the dependent request; and

a calling component that sends the first request to a service computing system hosting the hosted application, and prior to receiving a response to the first request, sends the preview information to the service computing system.

Example 2 is the computer system of any or all previous examples and further comprising:

a memory storing a dependency structure that identifies a plurality of requests made by the client component during execution of the hosted application and dependencies among the plurality of requests.

Example 3 is the computer system of any or all previous examples wherein the dependency structure has a first element identifying the first request, a second element identifying the dependent request and a link between the first element and the second element identifying the dependency of the dependent request on the first request.

Example 4 is the computer system of any or all previous examples wherein request dependency identifier is configured to traverse the dependency structure from the first element to the second element to identify the that the dependent request is dependent on the first request.

Example 5 is the computer system of any or all previous examples and further comprising:

a dependency structure generator configured to generate the dependency structure with the client component.

Example 6 is the computer system of any or all previous examples wherein the request dependency identifier is configured to identify a plurality of dependent requests, dependent on the first request and identify a priority corresponding to each of the plurality of dependent requests.

Example 7 is the computer system of any or all previous examples wherein the request dependency identifier is configured to generate preview information indicative of the plurality of dependent requests and the priority corresponding to each of the plurality of dependent requests.

Example 8 is the computer system of any or all previous examples and further comprising:

a request configuration system configured to add the preview information to the first request, the calling component sending the first request, with the preview information, to the service computing system.

Example 9 is the computer system of any or all previous examples wherein the request configuration system is configured to add the preview information to a location in the first request known to the service computing system.

Example 10 is the computer system of any or all previous examples wherein the request configuration system is configured to add the preview information to a hypertext transfer protocol (http) header on the first request.

Example 11 is the computer system of any or all previous examples and further comprising:

a request configuration system configured to generate a preview request, that is separate from the first request, including the preview information, the calling component sending the preview request to the service computing system prior to receiving the response to the first request.

Example 12 is a computer implemented method, comprising:

identifying, at a client component of a hosted application, a first request to submit to a service computing system;

identifying a dependent request, that is dependent on the first request;

generating preview information indicative of the dependent request;

sending the first request to a service computing system hosting the hosted application; and

prior to receiving a response to the first request, sending the preview information to the service computing system.

Example 13 is the computer implemented method of any or all previous examples wherein identifying a dependent request comprises:

accessing a dependency structure that identifies a plurality of requests made by the client component during execution of the hosted application and dependencies among the plurality of requests.

Example 14 is the computer implemented method of any or all previous examples wherein the dependency structure has a first element identifying the first request, a second element identifying the dependent request and a link between the first element and the second element identifying the dependency of the dependent request on the first request and wherein accessing the dependency structure comprises:

traversing the dependency structure from the first element to the second element to identify the that the dependent request is dependent on the first request.

Example 15 is the computer implemented method of any or all previous examples wherein identifying a dependent request comprises:

identifying a plurality of dependent requests, dependent on the first request; and

identifying a priority corresponding to each of the plurality of dependent requests, and wherein generating preview information comprises generating preview information indicative of the plurality of dependent requests and the priority corresponding to each of the plurality of dependent requests.

Example 16 is the computer implemented method of any or all previous examples wherein sending the preview information to the service computing system comprises:

adding the preview information to a location in the first request known to the service computing system; and

sending the preview information to the service computing system along with the first request.

Example 17 is the computer implemented method of any or all previous examples wherein sending the preview information to the service computing system comprises:

generating a preview request, that is separate from the first request, including the preview information; and

sending the preview request to the service computing system prior to receiving the response to the first request.

Example 18 is a computer implemented method, comprising:

receiving a first request, from a client computing system, at a service computing system;

receiving preview information, from the client computing system, indicative of a dependent request that is dependent on the first request;

executing the first request to obtain a response to the first request;

returning the response to the first request to the client computing system;

executing the dependent request to obtain a response to the dependent request prior to receiving the dependent request from the client computing system; and

returning the response to the dependent request to the client computing system.

Example 19 is the computer implemented method of any or all previous examples wherein returning the response to the dependent request comprises:

caching the response to the dependent request on the service computing system;

receiving the dependent request from the client computing system; and

returning the cached response to the dependent request to the client computing system.

Example 20 is the computer implemented method of any or all previous examples wherein returning the response to the dependent request comprises:

pushing the response to the dependent request to the client computing system, prior to receiving the dependent request from the client computing system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer system comprising:
at least one processor; and
memory storing instructions executable by the at least one processor, wherein the instructions, when executed, cause the computer system to:
identify, at a client component of a hosted application, a first request to submit to a service computing system that hosts the hosted application;
send the first request to the service computing system; and
prior to the computer system receiving a response to the first request,
identify, at the client component, a dependent request that is dependent on the first request,
generate preview information indicative of the dependent request, and
send the preview information to the service computing system.

2. The computer system of claim 1 wherein the instructions, when executed, cause the computer system to:
store a dependency structure that identifies a plurality of requests made by the client component during execution of the hosted application and dependencies among the plurality of requests.

3. The computer system of claim 2 wherein the dependency structure has a first element identifying the first request, a second element identifying the dependent request and a link between the first element and the second element identifying the dependency of the dependent request on the first request.

4. The computer system of claim 3 wherein the instructions, when executed, cause the computer system to traverse the dependency structure from the first element to the second element to identify that the dependent request is dependent on the first request.

5. The computer system of claim 2, wherein the instructions, when executed, cause the computer system to:
generate the dependency structure with the client component.

6. The computer system of claim 1 wherein the instructions, when executed, cause the computer system to:
identify a plurality of dependent requests, dependent on the first request;
identify a priority corresponding to each of the plurality of dependent requests; and
generate the preview information indicative of the plurality of dependent requests and the priority corresponding to each of the plurality of dependent requests.

7. The computer system of claim 6 wherein the computer system comprises a client computer system and the instructions, when executed, cause the client computer system to run the client component.

8. The computer system of claim 1 wherein the instructions, when executed, cause the computer system to:
add the preview information to the first request; and
send the first request, with the preview information, to the service computing system.

9. The computer system of claim 8 wherein the instructions, when executed, cause the computer system to add the preview information to a location in the first request known to the service computing system.

10. The computer system of claim 8 wherein the instructions, when executed, cause the computer system to add the preview information to a hypertext transfer protocol (http) header on the first request.

11. The computer system of claim 1 wherein the instructions, when executed, cause the computer system to:
generate a preview request, that is separate from the first request, including the preview information; and
send the preview request to the service computing system prior to receiving the response to the first request.

12. A computer implemented method, comprising:
identifying, by a client component of a hosted application, a first request to submit to a service computing system that hosts the hosted application;
identifying, by the client component, a dependent request that is dependent on the first request;
generating preview information indicative of the dependent request;
sending the first request to the service computing system; and
prior to the client component receiving a response to the first request, sending the preview information to the service computing system.

13. The computer implemented method of claim 12 wherein identifying a dependent request comprises:
accessing a dependency structure that identities a plurality of requests made by the client component during execution of the hosted application and dependencies among the plurality of requests.

14. The computer implemented method of claim 13 wherein the dependency structure has a first element identifying the first request, a second element identifying the dependent request and a link between the first element and the second element identifying the dependency of the dependent request on the first request and wherein accessing the dependency structure comprises:
traversing the dependency structure from the first element to the second element to identify the that the dependent request is dependent on the first request.

15. The computer implemented method of claim 12 wherein identifying a dependent request comprises:
identifying a plurality of dependent requests, dependent on the first request; and
identifying a priority corresponding to each of the plurality of dependent requests, and wherein generating preview information comprises generating preview information indicative of the plurality of dependent requests and the priority corresponding to each of the plurality of dependent requests.

16. The computer implemented method of claim 12 wherein sending the preview information to the service computing system comprises:
adding the preview information to a location in the first request known to the service computing system; and
sending the preview information to the service computing system along with the first request.

17. The computer implemented method of claim 12 wherein sending the preview information to the service computing system comprises:
generating a preview request, that is separate from the first request, including the preview information; and
sending the preview request to the service computing system prior to receiving the response to the first request.

18. A computer implemented method, comprising:
receiving a first request, from a client computing system, at a service computing system;
receiving preview information, from the client computing system, indicative of a dependent request that is dependent on the first request;
executing the first request to obtain a response to the first request;
returning the response to the first request to the client computing system;
executing the dependent request to obtain a response to the dependent request prior to receiving the dependent request from the client computing system; and
returning the response to the dependent request to the client computing system.

19. The computer implemented method of claim 18 wherein returning the response to the dependent request comprises:
caching the response to the dependent request on the service computing system;
receiving the dependent request from the client computing system; and
returning the cached response to the dependent request to the client computing system.

20. The computer implemented method of claim 18 wherein returning the response to the dependent request comprises:
pushing the response to the dependent request to the client computing system, prior to receiving the dependent request from the client computing system.
